(19) United States
(12) Patent Application Publication
(10) Pub. No.: US 2025/0364762 A1
(43) Pub. Date: Nov. 27, 2025

(54) ELECTRICAL CONNECTOR

(71) Applicant: V-General Technology Co., Ltd., New Taipei City (TW)

(72) Inventors: Po-Wen YEH, New Taipei City (TW); Tzu-Wei YEH, New Taipei City (TW); Yu-Lun YEH, New Taipei City (TW); Chien-Yeh LEE, New Taipei City (TW); Yu-Teng LIU, New Taipei City (TW)

(21) Appl. No.: 19/209,847

(22) Filed: May 16, 2025

(30) Foreign Application Priority Data
May 24, 2024 (TW) 113119371

(51) Int. Cl. H01R 13/6594

(52) U.S. Cl. CPC H01R 13/6594

(57) ABSTRACT

An electrical connector includes a shielding shell, a fixing portion group, a limiting portion group, an insulating plastic body group, a transmission conductor group, a differential contact portion, a substrate elastic contact portion, a horizontal extension portion, a first bending portion, a first inclined portion, a second bending portion, and a second inclined portion. The shielding shell is movably mounted to and removable from a circuit substrate by the fixing portion group and the limiting portion group, in such a way that a tool is directly inserted into a gap between the shielding shell and the circuit substrate to apply an upward force to quickly separate the electrical connector from the circuit substrate, or to realize separation through a clamping manner. Through point-to-surface contact between the second bending portion and the circuit substrate, conducting can be achieved without soldering.

### BACKGROUND OF THE INVENTION

### (a) Technical Field of the Invention

The present invention relates to an electrical connector that is directly insertable/removable and replaceable, without having to be discarded as a whole, and exhibits good durability and impedance, meeting the French repairability index.

### (b) Description of the Prior Art

With the rapid development of modern technology, the Universal Serial Bus (USB) interface has been widely used in various electronic devices in daily life.

Traditional USB connectors are mostly fixed on a circuit board by soldering, and this makes most USB connectors integrated with the circuit board and difficult to detach therefrom. When the USB connector is damaged due to daily use, it needs to be removed from the circuit board, which makes the repair process more complicated and may cause the repair cost to increase, or it may even have to be discarded, making it not meet the current French repairability index.

Even though there are related electrical connectors that meet the French repairability index, mounting and removing the shielding shell to/from a circuit board requires use of tools, and in addition, a substrate elastic contact portion that is set in contact with the circuit board is still too long, making the transmission distance for a signal to be returned increased to thereby further making the impedance and high-frequency characteristics poor, and is set in a double-row arrangement in a front-row-and-back-row fashion, where the double-row arrangement also increases the difficulty and complexity of operation, making it more likely to cause interference between the front row and back row.

### SUMMARY OF THE INVENTION

The main purpose of the objective of the present invention is to provide an electrical connector that enables, by means of a fixing portion group and a limiting portion group, quick mounting and removing by a user using a tool, and in addition, a substrate elastic contact portion being set in a single-row arrangement to reduce the difficulty and complexity of operation, making it not likely to cause interference problems, and being having a length that is proper and not excessively long so as to allow the transmission distance for returning of a signal to thereby effectively improve impedance and high-frequency characteristics, and furthermore, the substrate elastic contact portion being combinable with a circuit substrate without using a soldering manner, so as to make the present invention meeting the French repairability index.

The structure by which the present invention achieve the aforementioned main purpose comprises a shielding shell, a fixing portion group, a limiting portion group, an insulating plastic body group, a transmission conductor group, a differential contact portion, a substrate elastic contact portion, a horizontal extension portion, a first bending portion, a first inclined portion, a second bending portion, and a second inclined portion, wherein the fixing portion group and the limiting portion group are integrally formed on two sides of the shielding shell, and the insulating plastic body group is arranged in an interior of the shielding shell, and the transmission conductor group is combined with the insulating plastic body group, and the transmission conductor group further comprises the differential contact portion mentioned above, and the substrate elastic contact portion extends from one side of the differential contact portion and is set in a single-row arrangement, and the substrate elastic contact portion comprises the horizontal extension portion mentioned above, and the first bending portion is formed by extending from one side of the horizontal extension portion, and the first inclined portion is formed by extending from one side of the first bending portion, and the second bending portion is formed by extending from one side of the first inclined portion, and the second inclined portion is formed by extending from one side of the second bending portion, and a length of the first inclined portion is greater than or equal to a length of the second inclined portion.

As such, to mount the electrical connector to a circuit substrate, the shielding shell is directly inserted vertically into an appropriate position on the circuit substrate, so that the shielding shell is firmly fixed and positioned on the circuit substrate by the fixing portion group and the limiting portion group. During the vertical insertion, the substrate elastic contact portion of the transmission conductor group is brought into elastic pressing contact with the circuit substrate, so that due to an elastic structure formed by the first bending portion, the first inclined portion, the second bending portion, and the second inclined portion, the substrate elastic contact portion is set in a more stable contact engagement with the circuit substrate, with no occurrence of separation therefrom. Conversely, to remove the electrical connector, it only needs to directly apply force upward to the shielding shell, and the fixing portion group and the limiting portion group are brought into a condition of separating from the circuit substrate, and due to the substrate elastic contact portion not using soldering technology, the shielding shell can be quickly removed, achieving the advantages of rapid repair or replacement, and meeting the French repairability index.

The above-described technology helps solve the problems existing in the prior art electrical connectors that even though there are related electrical connectors that meet the French repairability index, inserting and removing of the shielding shell on a circuit substrate still need to use tools to perform complex mounting and removing operations, and the substrate elastic contact portion that is set in contact engagement with the substrate is still too long so as to increase the transmission distance of returning of signals and further result in poor impedance and high-frequency characteristics, and is mostly set in a double-row arrangement of in a front-row-and-back-row fashion, such a double-row arrangement increasing the difficulty and complexity of operation and being more likely to cause interference between the front and back rows, so that the practical and progressive advantages of the present invention as mentioned above can be achieved.

### BRIEF DESCRIPTION OF THE DRAWINGS

FIG. 1 is a perspective see-through view showing a first preferred embodiment of the present invention.

FIG. 2 is a side elevational view showing the first preferred embodiment of the present invention.

FIG. 3 is an exploded view showing the first preferred embodiment of the present invention.

FIG. 4 is a perspective see-through view showing a second preferred embodiment of the present invention.

FIG. 5 is a perspective see-through view showing a third preferred embodiment of the present invention.

FIG. 6 is a perspective see-through view showing a fourth preferred embodiment of the present invention.

FIG. 7 is a perspective view showing a fifth preferred embodiment of the present invention.

FIG. 8 is a perspective view showing a sixth preferred embodiment of the present invention.

FIG. 9 is a perspective view showing a seventh preferred embodiment of the present invention.

FIG. 10 is a perspective view showing an eighth preferred embodiment of the present invention.

FIG. 11 is a schematic view showing one way of implementation of the eighth preferred embodiment of the present invention.

### DETAILED DESCRIPTION OF THE PREFERRED EMBODIMENTS

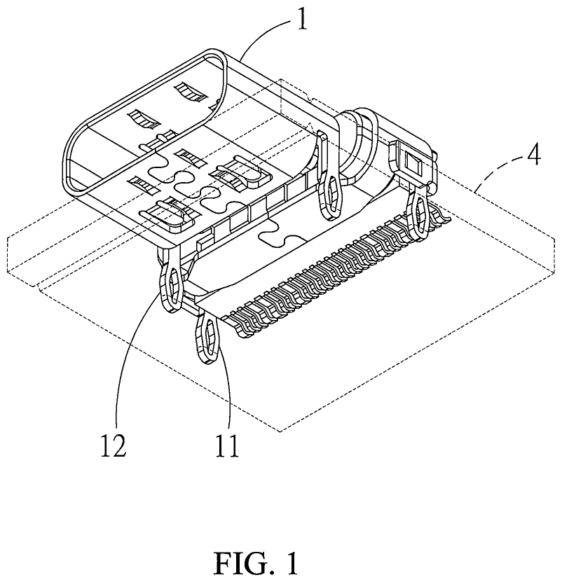

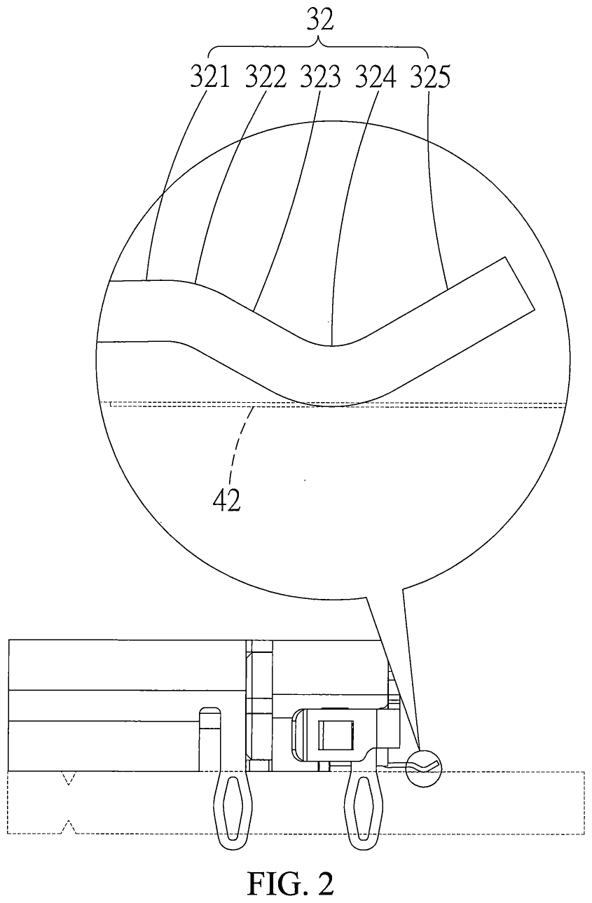

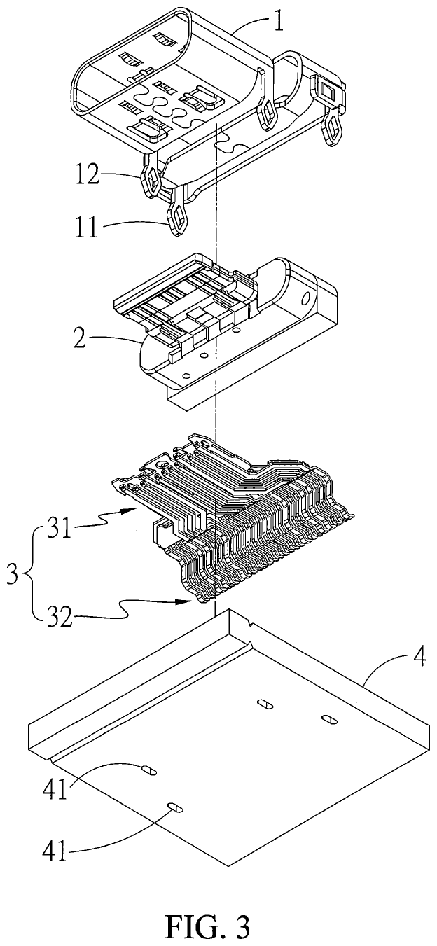

Referring to FIGS. 1-3, which are respectively a perspective see-through view, a side elevational view, and an exploded view showing a first preferred embodiment of the present invention, it is clearly seen from the drawings that the present invention comprises:
a shielding shell 1, which comprises a fixing portion group 11 that allows the shielding shell 1 to be movably mounted to or removed from a circuit substrate 4 and a limiting portion group 12 that is arranged at one side of the fixing portion group 11;
an insulating plastic body group 2, which is received in the shielding shell 1; and
a transmission conductor group 3, which is combined with the insulating plastic body group 2 and comprises a differential contact portion 31 and a substrate elastic contact portion 32 that is formed by extending from the differential contact portion 31 and is set in a single-row arrangement, wherein the substrate elastic contact portion 32 comprises a horizontal extension portion 321, a first bending portion 322 that is formed by extending from the horizontal extension portion 321, a first inclined portion 323 that is formed by extending from the first bending portion 322, a second bending portion 324 that is formed by extending from the first inclined portion 323, and a second inclined portion 325 that is formed by extending from the second bending portion 324, and a length of the first inclined portion 323 is greater than or equal to a length of the second inclined portion 325.

In the above, the shielding shell 1 of the instant embodiment is integrally formed as one piece.

In the above, as an example of illustration, the fixing portion group 11 and the limiting portion group 12 of the instant embodiment are both made in a harpoon type.

In the above, the transmission conductor group 3 of the instant embodiment complies with Type-C USB transmission protocol.

In the above, when the substrate elastic contact portion 32 is not in contact with the circuit substrate 4, a slope of the first inclined portion 323 is greater than a slope of the second inclined portion 325.

In the above, in the instant embodiment, the circuit substrate 4 includes substrate fixing holes 41 for receiving insertion of the fixing portion group 11 and the limiting portion group 12 therein, and the circuit substrate 4 also includes a metal contact region 42 for receiving the substrate elastic contact portion 32 to contact therewith.

To mount the electrical connector, the shielding shell 1 can be directly inserted vertically downward on the circuit substrate 4, in such a way that the fixing portion group 11 and the limiting portion group 12 that are of a harpoon type are inserted into and fixed in the substrate fixing holes 41, so as to achieve the advantage of quick mounting, and on the contrary, when the electrical connector is damaged and fails, the electrical connector can be removed individually by only using a tool that is inserted directly into a gap between the shielding shell 1 and the circuit substrate 4 and applies an upward force to quickly separate the electrical connector from the circuit substrate 4, without a complicated and tedious process of removal. Obviously, through the advantage of removing and replacing one single part, there is no need to discard the entire circuit substrate 4 including the electrical connector, thereby achieving the concept of cost saving and environmental protection, and having the greatest advantages of quick mounting, stability, quick removal, and easy removal.

Further, during the course of vertically inserting the shielding shell 1 downward to the circuit substrate 4, the second bending portion 324 of the substrate elastic contact portion 32 will first contact the metal contact region 42, and during further and continuous insertion of the shielding shell 1 in the direction toward the circuit substrate 4, the second bending portion 324 will slightly move by friction on the metal contact region 42, and the first bending portion 322 changes the bending angle thereof, so that the inclination angle of the first inclined portion 323 becomes smaller, meaning the pressing force that the second bending portion 324 presses against the metal contact region 42 is increased; therefore, no matter how deep the fixing portion group 11 and the limiting portion group 12 are inserted into the substrate fixing holes 41, as long as the second bending portion 324 presses against the metal contact region 42, electrical conduction is established, and thus, the present invention has a buffer zone with a larger insertion depth, and even if the insertion does not reach the deepest location, the transmission conductor group 3 can still be set in a conducting condition, and only the bending angle of the first bending portion 322 and the inclination angle of the first inclined portion 323 will be changed.

Further, since the length of the first inclined portion 323is greater than or equal to the length of the second inclined portion 325, the transmission distance for a signal to be returned is shortened, and the impedance and high-frequency characteristics are effectively improved. In other words, the substrate elastic contact portion 32 has no other structure at the end of the second inclined portion 325, and there is no other bending portion extended further therefrom. Therefore, a signal, when passing through the second bending portion 324 to reach the end of the second inclined portion 325, will be returned immediately, so as to effectively shortening the returning time, making the high-frequency characteristics and impedance more stable.

As such, by means of the above structure, the substrate elastic contact portion 32 can be set in contact with the metal contact region 42 of the circuit substrate 4 without using soldering technology, and the transmission is made stable. Therefore, after the fixing portion group 11 and the limiting portion group 12 are detached, the substrate elastic contact portion 32 requires no removal of soldering and can be directly taken out, and this meets the standard of the French repairability index.

Further, since the substrate elastic contact portion 32 is set in a horizontal single-row arrangement, rather than a double-row arrangement, problems of mutual interference may not easily occur during the operation of the electrical connector.

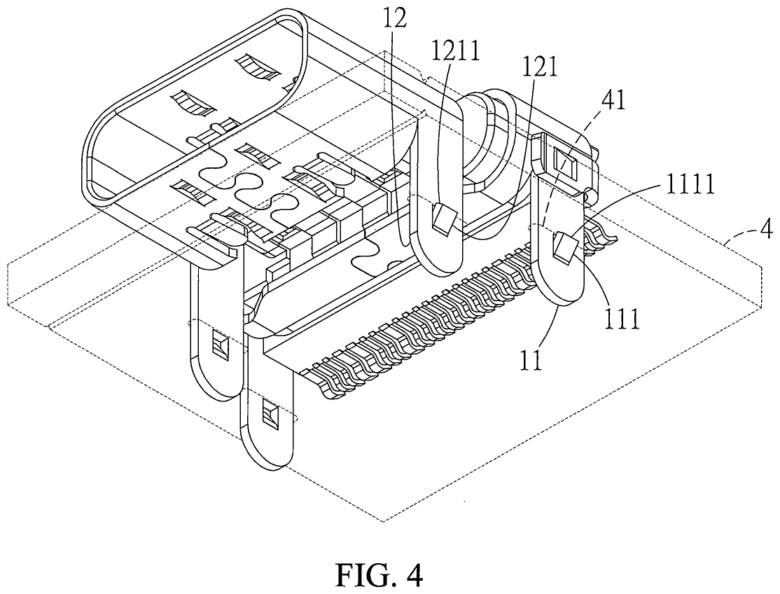

Referring to FIG. 4, which is a perspective see-through view showing a second preferred embodiment of the present invention, the instant embodiment is different from the first preferred embodiment in that in the instant embodiment, the fixing portion group 11 and the limiting portion group 12 are both of a concave-convex latching type. The so-called concave-convex latching type means that the fixing portion group 11 and the limiting portion group 12 are each made to include an integrally formed inclined block 111, 121 that is punched convex and torn, and a latching surface 1111, 1211 is formed at an end of the inclined block 111, 121. This means when the electrical connector is inserted into the substrate fixing holes 41 of the circuit substrate 4, the inner side wall surfaces of the substrate fixing holes 41 compress the surfaces of the inclined blocks 111, 121, making the inclined blocks 111, 121 deformed inwards. The inclined blocks 111, 121, after the inclined surfaces thereof passing through the inner side wall surfaces of the substrate fixing holes 41, will restore the original state immediately, and the latching surface 1111, 1211 will abut against the lower surface of the circuit substrate 4 so as to achieve the advantage of quick assembly. Conversely, to remove the electrical connector, it only needs to use a tool to clamp the inclined surface of the inclined block 111, 121 to make the inclined block 111, 121 retract inwards and the latching surface 1111, 1211 separated from the lower surface of the circuit substrate 4, and then, the fixing portion group 11 or the limiting portion group 12 can be acted upon by a force in an upward direction to be removed therefrom, achieving the advantage of quick disassembly.

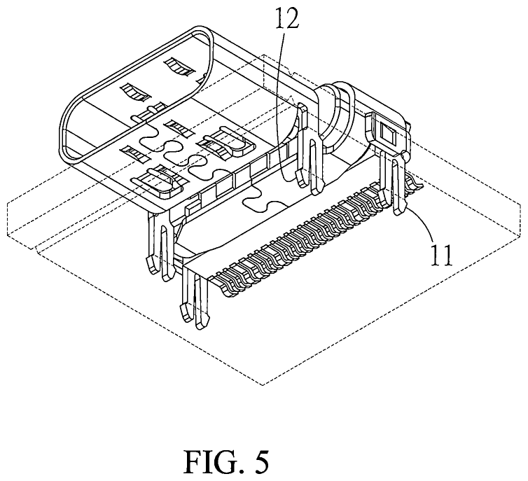

Referring to FIG. 5, which is a perspective see-through view showing a third preferred embodiment of the present invention, the instant embodiment is different from the first preferred embodiment in that in the instant embodiment, the fixing portion group 11 and the limiting portion group 12 are both of a harpoon type. To disassemble, it only needs to use a tool to clamp two sides of the fixing portion group 11 or the limiting portion group 12 in a clamping manner to cause deformation thereof, and at this moment, the fixing portion group 11 or the limiting portion group 12 can be detached upwards. Therefore, when the fixing portion group 11 and the limiting portion group 12 are both of the harpoon type, the greatest advantage of the present invention of quick mounting, being stable, quick removing, and easy removing can be demonstrated.

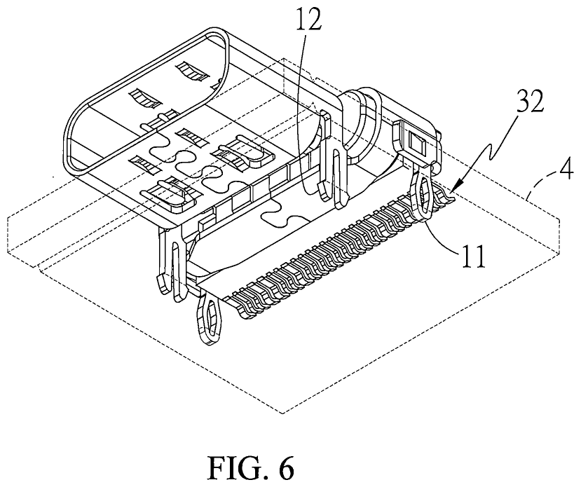

Referring to FIG. 6, which is a perspective see-through view showing a fourth preferred embodiment of the present invention, the instant embodiment is different from the first preferred embodiment in that in the instant embodiment, the fixing portion group 11 is of a fisheye type, while the limiting portion group 12 is of a harpoon type. This is another style of fixing, in which by means of the fixing portion group 11 of the fisheye type, the substrate elastic contact portion 32 is kept in stable contact with the metal contact region of the circuit substrate 4, without easy occurrence of separation therefrom.

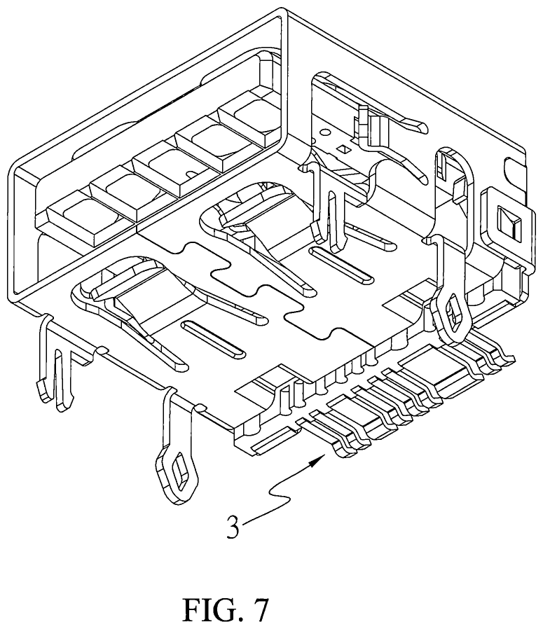

Referring to FIG. 7, which is a perspective view showing a fifth preferred embodiment of the present invention, the instant embodiment is different from the first preferred embodiment in that in the instant embodiment, the transmission conductor group 3 of the electrical connector complies with Type A USB transmission protocol, meaning the electrical connector of the present invention is not limited to a certain style, and the technology of the present invention can be applied to Type A USB, to provide the electrical connector of Type A USB with similar advantages of quick mounting, being stable, quick removing, and easy removing.

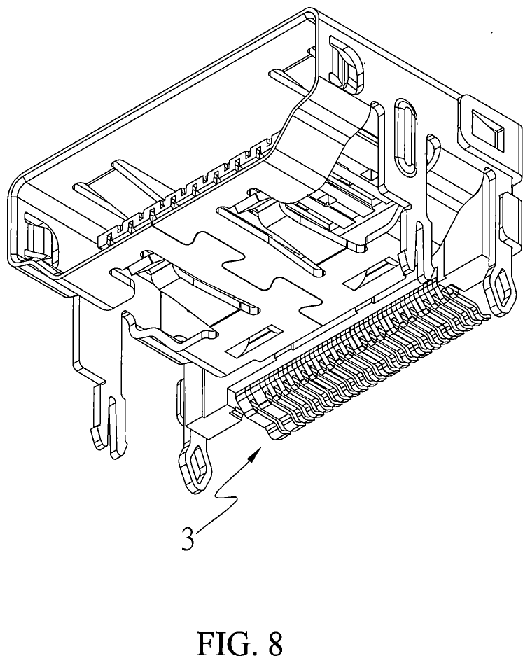

Referring to FIG. 8, which is a perspective view showing a sixth preferred embodiment of the present invention, the instant embodiment is different from the first preferred embodiment in that in the instant embodiment, the transmission conductor group 3 of the electrical connector complies with High-Definition Multimedia Interface (HDMI) transmission protocol, meaning the electrical connector of the present invention is not limited to a certain style, and the technology of the present invention can be applied to HDMI, to provide the electrical connector of HDMI with similar advantages of quick mounting, being stable, quick removing, and easy removing.

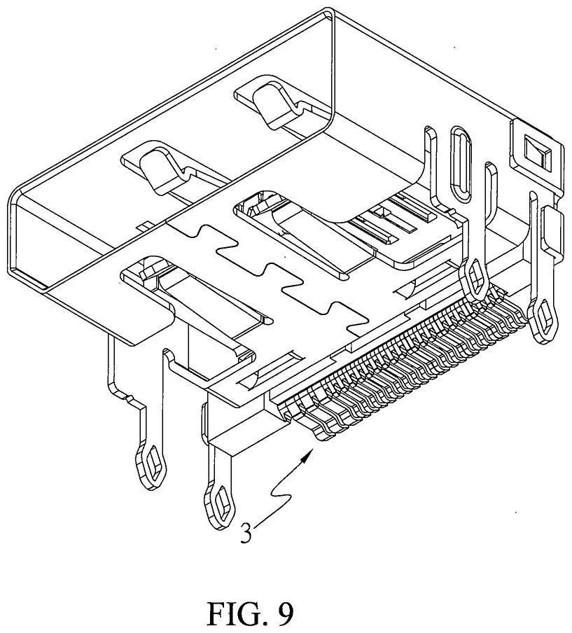

Referring to FIG. 9, which is a perspective view showing a seventh preferred embodiment of the present invention, the instant embodiment is different from the first preferred embodiment in that in the instant embodiment, the transmission conductor group 3 of the electrical connector complies with DisplayPort (DP) transmission protocol, meaning the electrical connector of the present invention is not limited to a certain style, and the technology of the present invention can be applied to DP, to provide the electrical connector of DP with similar advantages of quick mounting, being stable, quick removing, and easy removing.

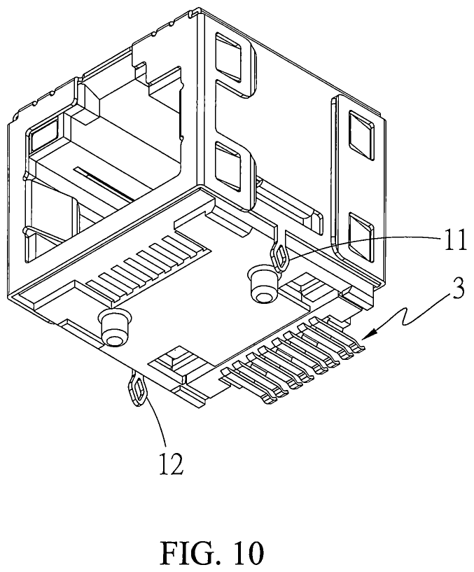

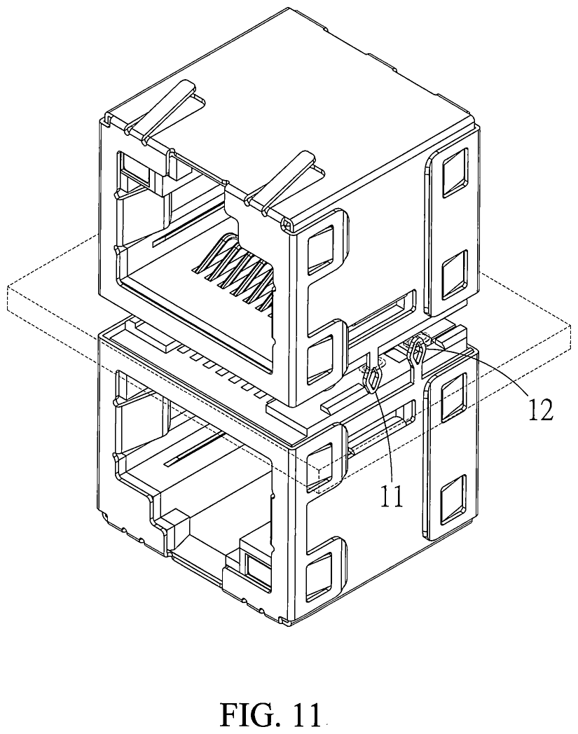

Referring to FIGS. 10 and 11, which are a perspective view showing an eighth preferred embodiment of the present invention and a schematic view showing one way of implementation thereof, the instant embodiment is different from the first preferred embodiment in that in the instant embodiment, the transmission conductor group 3 of the electrical connector complies with Registered Jack (RJ) transmission protocol, and in the instant embodiment, the fixing portion group 11 including one single pin is taken as an example for illustration, and the limiting portion group 12 including one single pin is taken as an example for illustration of the instant embodiment, and the fixing portion group 11 and the limiting portion group 12 are arranged in a position-staggered manner to prevent mutual interference when the electrical connector is set in a multiple-stacked arrangement, as shown in FIG. 11.

I claim:

1. An electrical connector, the electrical connector comprising:
a shielding shell, which comprises a fixing portion group that allows the shielding shell to be movably mountable to or removable from a circuit substrate and a limiting portion group that is arranged at one side of the fixing portion group;
an insulating plastic body group, which is received in the shielding shell; and
a transmission conductor group, which is combined with the insulating plastic body group and comprises a differential contact portion and a substrate elastic contact portion that is formed by extending from the differential contact portion and is set in a single-row arrangement, wherein the substrate elastic contact portion comprises a horizontal extension portion, a first bending portion that is formed by extending from the horizontal extension portion, a first inclined portion that is formed by extending from the first bending portion, a second bending portion that is formed by extending from the first inclined portion, and that is formed by extending from second inclined portion that is formed by extending from the second bending portion, and a length of the first inclined portion is greater than or equal to a length of the second inclined portion.

2. The electrical connector according to claim 1, wherein the shielding shell is integrally formed as one piece.

3. The electrical connector according to claim 1, wherein the fixing portion group is of a type of one of a fisheye type, a harpoon type, and a concave-convex latching type.

4. The electrical connector according to claim 3, wherein the fixing portion group is of the concave-convex latching type, and the fixing portion group comprises an integrally formed inclined block that is formed by being punched convex and torn.

5. The electrical connector according to claim 1, wherein the limiting portion group is of a type of one of a fisheye type, a harpoon type, and a concave-convex latching type.

6. The electrical connector according to claim 5, wherein the limiting portion group is of the concave-convex latching type, and the limiting portion group comprises an integrally formed inclined block that is formed by being punched convex and torn.

7. The electrical connector according to claim 1, wherein the transmission conductor group complies with one of Type-C Universal Serial Bus (USB) transmission protocol, Type-A USB transmission protocol, High-Definition Multimedia Interface (HDMI) transmission protocol, DisplayPort (DP) transmission protocol, and Registered Jack (RJ) transmission protocol.

8. The electrical connector according to claim 1, wherein the fixing portion group comprises at least one first fixing portion, and the limiting portion group comprises at least one first limiting portion that is arranged to be staggered with respect to the first fixing portion, so as to allow the electrical connector to be set in a multiple-stacked arrangement.
